(19) United States
(12) Patent Application Publication
(10) Pub. No.: US 2026/0140754 A1
(43) Pub. Date: May 21, 2026

(54) DEBUGGING OF PARTITIONED VIRTUALIZED HARDWARE RESOURCES

(71) Applicant: ATI TECHNOLOGIES ULC, Markham (CA)

(72) Inventor: Ting-Yu Lin, Toronto (CA)

(21) Appl. No.: 18/950,637

(22) Filed: Nov. 18, 2024

(51) Int. Cl. G06F 9/455; G06F 9/50

(52) U.S. Cl. CPC G06F 9/45558; G06F 9/5077; G06F 2009/45591

(57) ABSTRACT

A software service such as a daemon monitors traffic at virtual com ports of virtual machines to facilitate debugging of virtual functions in real time as the virtual functions take turns using a hardware resource in round-robin fashion. If the daemon detects that a kernel debugger has initiated a kernel debugging session for a particular virtual function via the com port, the monitor halts world switching between virtual functions allocated to the hardware resource. The daemon makes the virtual function indicated by the kernel debugger the active partition while the kernel debugger reads one or more registers of the hardware resource allocated to the virtual function. When the kernel debugger has completed reading the register(s), the daemon signals the host to resume world switching between the virtual functions.

### BACKGROUND

Processing systems utilize virtualization to allow the sharing of physical resources of a host system between different virtual machines (VMs) or guests. VMs are software abstractions of physical computing resources that emulate an independent computer system, thereby allowing multiple operating system environments to exist simultaneously on the same computer system. The host system allocates a certain amount of its physical resources to each of the VMs so that each guest is able to use the allocated resources to execute applications. The virtual environment implemented on the host system also provides virtual functions to other virtual components implemented on a physical machine. A single physical function implemented in a physical resource of the host system such as a parallel processor is used to support one or more virtual functions (VFs).

The physical function allocates the virtual functions to different VMs on the physical machine on a time-sliced or time-partitioned basis. For example, the physical function allocates a first virtual function to a first VM in a first time interval and a second virtual function to a second VM in a second, subsequent time interval. A switch between virtual machines (in either direction) at each time interval is often referred to as a “world switch”. The single root input/output virtualization (SR-IOV) specification allows multiple VMs to share a physical resource interface to a single bus, such as a peripheral component interconnect express (PCIe) bus. Components access the virtual functions by transmitting requests over the bus.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system implementing a monitor for debugging a virtualized hardware resource in accordance with some embodiments.

FIG. 2 is a block diagram illustrating partitioning of a virtualized hardware resource in accordance with some embodiments.

FIG. 3 is a block diagram illustrating the monitor halting world switching at the virtualized hardware resource and switching an active partition to a virtual function based on a request from a debugger in accordance with some embodiments.

FIG. 4 is a flow diagram illustrating a method for switching an active partition of a virtualized hardware resource to a virtual function based on a request from a debugger in accordance with some embodiments.

### DETAILED DESCRIPTION

The hardware resources such as a parallel processor, network switch, and Ethernet card are partitioned according to SR-IOV using a physical function (PF) and one or more virtual functions (VFs). Each virtual function is associated with a single physical function. In a native (host OS) environment, a physical function is used by native user mode and kernel-mode drivers and all virtual functions are disabled. All the registers of the hardware resource are assigned to the physical function via trusted access. In a virtual environment, the physical function is used by a hypervisor (host VM) and the hardware resource exposes a certain number of virtual functions as per the PCIe SR-IOV standard, such as one virtual function per guest VM. Each virtual function is assigned to the guest VM by the hypervisor.

Typically, central processing units (CPUs) are partitioned across virtual functions, such that each virtual function has a dedicated virtualized CPU. The virtual CPU prepares and submits jobs to a hardware resource such as a parallel processor, network switch, or Ethernet card for the virtual function. Each virtual function receives remote user input and prepares job submissions based on the remote user input and may also submit jobs orthogonal to user input. The virtual CPU may submit jobs to the hardware resource for the virtual function at any time; however, execution of the jobs on the hardware resource occurs during a time partition assigned to the virtual function. Typically, time partitions of the hardware resource are assigned to virtual functions in a round-robin fashion, in which each virtual function is active for a time slice (e.g., 6 ms) before a world switch that saves the context of the active virtual function and loads the context for the next virtual function which then becomes active for the following time slice. The virtual functions allocated to the hardware resource take turns as the active partition until all the virtual functions have had a turn, after which the cycle repeats with the first virtual function becoming the active partition.

If one of the virtual functions encounters a software error while executing at the virtualized hardware resource, a debugger associated with the virtual function initiates a debugging session that halts the virtual CPU so the debugger can check the status of the virtual function at hardware registers assigned to the virtual function and analyze the code that is being executed in real time. However, in conventional processing systems, the round-robin rotation of time partitions among the virtual functions continues at the virtualized hardware resource during the debugging session. Because the values stored at the hardware registers change at each world switch as a new virtual function becomes the active partition, the status of the hardware registers at the time the debugger inspects them may not reflect the real value of the registers for the virtual function that was the active partition at the time the error occurred if world switching continues during the debugging session. The uncertainty of the validity of the register values significantly complicates the debugging process.

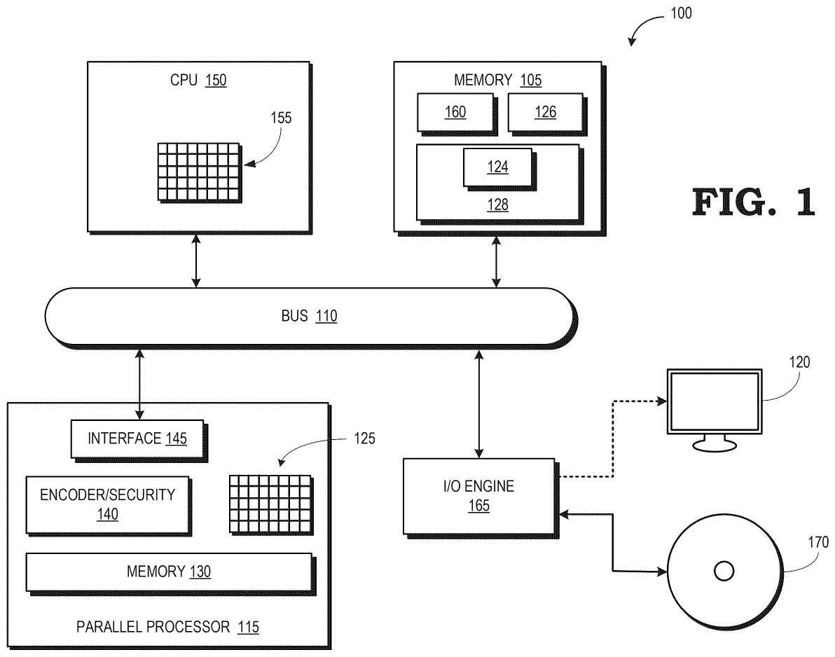

FIGS. 1-4 illustrate techniques for debugging time-partitioned virtualized hardware resources of a processing system. When each virtual function (VF) is created, it is configured with a virtual serial port, referred to as a virtual com port (or simply “com port”), that allows the VF to communicate with a serial device port by sending serial data over a local area network. A kernel debugger at the host communicates with each VF via the VF's com port. To facilitate debugging of VFs in real time as the VFs take turns using a hardware resource in round-robin fashion, a software service such as a daemon (referred to herein as a “monitor”) monitors traffic at the com ports. If the monitor detects that a kernel debugger has initiated a kernel debugging session for a particular VF via the com port between the guest VF and the host, the monitor signals the host to halt world switching between VFs allocated to the hardware resource. The monitor then signals the host to world switch to make the VF indicated by the kernel debugger the active partition while the kernel debugger reads one or more registers of the hardware resource allocated to the VF. When the kernel debugger has completed reading the register(s), the monitor signals the host to resume world switching between VFs. Thus, world switching among VFs can resume even while debugging is taking place for the affected VF. In some implementations, the monitor selectively signals the host to skip the VF that had the kernel debugging session at the next iteration of the round robin rotation of active partitions of the virtualized hardware resource to facilitate fair allocation of active partitions among the VFs sharing the virtualized hardware resource.

FIG. 1 is a block diagram of a processing system 100 configured to implement a monitor for debugging a virtualized hardware resource in accordance with some embodiments. The techniques described herein are, in different embodiments, employed at any of a variety of hardware resources such as network switches, Ethernet cards, and parallel processors, such as vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like. FIG. 1 illustrates an example of a parallel processor 115 (e.g., a virtual GPU), in accordance with some embodiments. Reference to a GPU herein will be understood to include any of a variety of parallel processors unless otherwise noted. The processing system 100, in at least some implementations, is a computer, laptop, mobile device, server, vehicle human-machine interface, or any of various other types of computing systems or devices. It is noted that the number of components of the processing system 100 may vary. It is also noted that in some implementations, the processing system 100 includes other components not shown in FIG. 1, and the processing system 100, in at least some implementations, is structured differently than shown in FIG. 1.

The processing system 100 includes or has access to a memory 105 or other storage component that is implemented using a non-transitory computer readable medium such as a dynamic random-access memory (DRAM). However, the memory 105 can also be implemented using other types of memory including static random-access memory (SRAM), nonvolatile RAM, and the like. The processing system 100 also includes a bus 110 to support communication between entities implemented in the processing system 100, such as the memory 105. In the illustrated embodiment, the bus 110 is configured as a PCIe bus. Some embodiments of the processing system 100 include other buses, bridges, switches, routers, and the like, which are not shown in FIG. 1 in the interest of clarity.

The processing system 100 also includes a central processing unit (CPU) 150 that is connected to the bus 110 and communicates with the parallel processor 115 and the memory 105 via the bus 110. In the illustrated embodiment, the CPU 150 implements multiple processing elements (also referred to as processor cores) 155 that are configured to execute instructions concurrently or in parallel. The CPU 150 executes instructions such as program code 160 stored in the memory 105 and the CPU 150 stores information in the memory 105 such as the results of the executed instructions. The CPU 150 initiates graphics processing by issuing draw calls to the parallel processor 115.

An input/output (I/O) engine 165 handles input or output operations associated with a display 120, as well as other elements of the processing system 100 such as keyboards, mice, printers, external disks, network, and the like. The I/O engine 165 is coupled to the bus 110 so that the I/O engine 165 communicates with the memory 105, the GPU 115, or the CPU 150. In the illustrated embodiment, the I/O engine 165 is configured to read information stored on an external storage component 170, which is implemented using a non-transitory computer readable medium such as a flash drive and the like. The I/O engine 165 can also write information to the external storage component 170, such as the results of processing by the parallel processor 115 or the CPU 150. The display 120 can be remotely connected to a VM through network connection with appropriate protocols.

The processing system 100 includes one or more hardware resources such as parallel processor 115, which is configured to render images for presentation on a display 120. For example, the parallel processor 115 can render objects to produce values of pixels that are provided to the display 120, which uses the pixel values to display an image that represents the rendered objects. Some implementations of the parallel processor 115 are used for general purpose computing. The parallel processor 115 executes instructions such as program code stored in the memory 105 and the parallel processor 115 stores information in the memory 105 such as the results of the executed instructions. The parallel processor 115 includes a parallel processor core 125 that is made up of a set of compute units, a set of fixed function units, or a combination thereof for executing instructions concurrently or in parallel. The parallel processor core 125 can include tens, hundreds, or even thousands of compute units or fixed function units for executing instructions.

The parallel processor 115 includes an internal (or on-chip) memory 130 that includes a frame buffer and a local data store (LDS), as well as caches, registers, or other buffers utilized by the compute units in the parallel processor core 125. The internal memory 130 stores data structures that describe tasks executing on one or more of the compute units or fixed function units in the parallel processor core 125. The compute units or fixed function units in the parallel processor core 125 are also able to access information in the (external) memory 105. In the illustrated embodiment, the parallel processor 115 communicates with the memory 105 over the bus 110. However, some embodiments of the parallel processor 115 communicate with the memory 105 over a direct connection or via other buses, bridges, switches, routers, and the like. The parallel processor 115 executes instructions stored in the memory 105 and the parallel processor 115 stores information in the memory 105 such as the results of the executed instructions. For example, the memory 105 can store a copy of instructions from a program code that is to be executed by the parallel processor 115 such as program code that represents a shader, a virtual function, or other code that is executed by one or the compute units or fixed function units implemented in the parallel processor core 125.

The parallel processor 115 includes an encoder 140 that is used to encode information for transmission over the bus 110. The encoder 140 also provides security functionality to support secure communication over the bus 110. In some embodiments, the encoder 140 encodes values of pixels for transmission to the display 120, which implements a decoder to decode the pixel values to reconstruct the image for presentation. The display 120 can be remotely connected to a VM via a network connection. Some embodiments of the encoder 140 encode and encrypt information generated by the virtual functions implemented on the parallel processor 115 for communication via the bus 110.

Some embodiments of the parallel processor 115 operate as a physical function that supports one or more virtual functions that are shared over the bus 110. For example, the parallel processor 115 can use dedicated portions of the bus 110 to securely share a number of VMs using SR-IOV standards defined for a PCIe bus. The parallel processor 115 includes a bus interface 145 that provides an interface between the parallel processor 115 and the bus 110, e.g., according to the SR-IOV standards. The bus interface 145 provides functions including doorbell detection, register redirection, frame buffer apertures, doorbell write redirection, as well as other functions.

The processing system (also referred to as a “host processing system” or a “host,” for brevity) employs a hypervisor 128 to create the VMs, manage the VMs, and provide an interface between the host's hardware resources and the VMs. The hypervisor 128 is software that provides the virtualization capability. Typically, the hypervisor 128 provides each guest the appearance of full control over a complete computer system (i.e., memory, central processing unit (CPU) and all peripheral devices).

One or more debuggers 124 execute in the background at the hypervisor 128. A debugger 124 initiates a kernel debugging session by, e.g., issuing an interrupt command that temporarily halts the CPU 150 while the debugger 124 inspects register values to determine whether a malfunction has occurred. However, if round-robin partitioning of the parallel processor 115 continues uninterrupted, the register values at the time of inspection by the debugger 124 may not reflect the register values of the VM that was executing at the time the change in processing system resources was detected.

To facilitate debugging of VFs, the processing system 100 includes a monitor 126 configured to monitor communications between the one or more debuggers 124 and the VFs. In response to a debugger 124 initiating a kernel debugging session with one of the VFs, the monitor 126 determines the identity of the VF for which the debugger 124 has initiating the kernel debugging session. For example, in some implementations, each VF is allocated particular registers by the hypervisor 128. Each VF's copy of registers may be a hardware implementation of duplicated sets of registers allocated by the hypervisor 128 or host OS. In response to a debugger 124 requesting access to one or more registers, the monitor 126 identifies the VF to which the one or more registers are allocated as the VF for which the kernel debugging session has been initiated. The monitor 126 halts round-robin world switching between VFs and initiates a world switch to the identified VF. The debugger 124 then reads the requested register(s) to perform debugging. Once the debugger 124 has accessed the register(s), the monitor 126 re-initiates round-robin world switching between VFs. By halting the round-robin world switching and switching to the identified VF, the monitor 126 allows the debugger 124 to read the register values associated with the identified VF rather than register values associated with a different VF, as would potentially occur if round-robin world-switching had continued uninterrupted.

The monitor 126 is hardware circuitry designed and configured to perform the corresponding operations described herein. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In other embodiments, the monitor 126 is a set of instructions (e.g., software) executed at, for example, the CPU 150 or the parallel processor 115, such that, when executed, the CPU 150 or the parallel processor 115 perform the operations described herein.

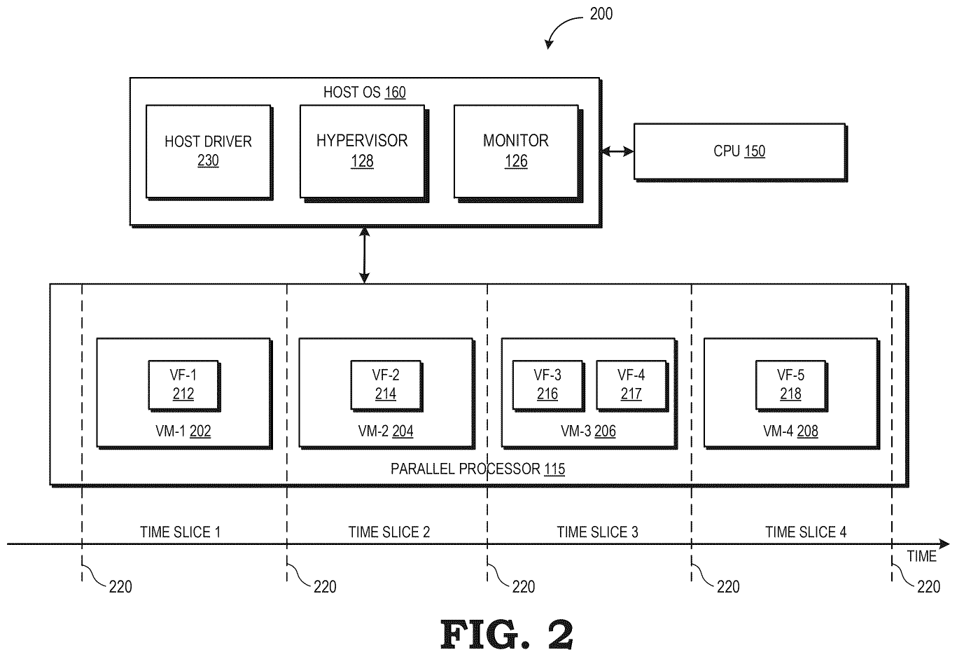

FIG. 2 is a block diagram 200 illustrating partitioning of a virtualized hardware resource in accordance with some embodiments. Virtualization of hardware resources of the processing system 100 is used to hide physical characteristics of the processing system 100 from software executing on the computing system referred to as a user or a guest and instead, presents an abstract emulated processing system (i.e., a virtual machine (VM)) to the user. Physical hardware resources of the processing system 100 are exposed to one or more guests such as one or more corresponding isolated, apparently independent, virtual machines VM-1 202, VM-2 204, VM-3 206 and VM-4 208. For example, a virtual machine may include one or more virtual resources that are implemented by physical resources of the processing system 100, such as the parallel processor 115, that the hypervisor 128 allocates to the virtual machine. In some cases, each virtual machine is associated with a single virtual function; however, in other cases, a virtual machine is associated with multiple virtual functions (e.g., two or more instances of the parallel processor 115). In the illustrated example, each of VM-1 202, VM-2 204, and VM-4 208 is associated with as single virtual function (VF-1 212, VF-2 214, and VF-5 218, respectively), while VM-3 206 is associated with two virtual functions, VF-3 216 and VF-4 217.

The virtualized hardware resource (the parallel processor 115 in the illustrated example) switches between execution of hypervisor 128 and execution of one or more guests VM-1 202, VM-2 204, VM-3 206 and VM-4 208. As referred to herein, a world switch 220 is a switch between execution of a guest and execution of the hypervisor 128 or a switch between execution of a first guest (e.g., VM-1 202) and a second guest (e.g., VM-2 204). In general, a world switch 220 may be initiated by a host driver 230 or by other suitable techniques, e.g., interrupt mechanisms or predetermined instructions defined by a control block. During a world switch 220, a current active guest (e.g., VM-1 202) saves its state information and the hypervisor 128 restores state information for a target guest (e.g., VM-2 204) to which the hardware resource execution is switched. For example, the host driver 230 executes a world switch 220 when the hypervisor 128 executes a guest that was scheduled for execution. In some implementations, the host driver 230 rotates time slices among the virtual machines VM-1 202, VM-2 204, VM-3 206 and VM-4 208 at the parallel processor 115 in a round-robin fashion. In other words, in a first time slice, VM-1 202 executes at the parallel processor 115, after which the host driver 230 executes a world switch 220. Execution then passes to VM-2 204, which executes at the parallel processor 115 during a second time slice until the next world switch 220. Following VM-2 204, VM-3 206 executes at the parallel processor 115 during a third time slice until the next world switch 220. VM-4 208 executes at the parallel processor 115 after VM-3 206, during a fourth time slice, after which another world switch 220 is executed and the cycle repeats with VM-1 202 executing at the parallel processor 115 in a fifth time slice (not shown).

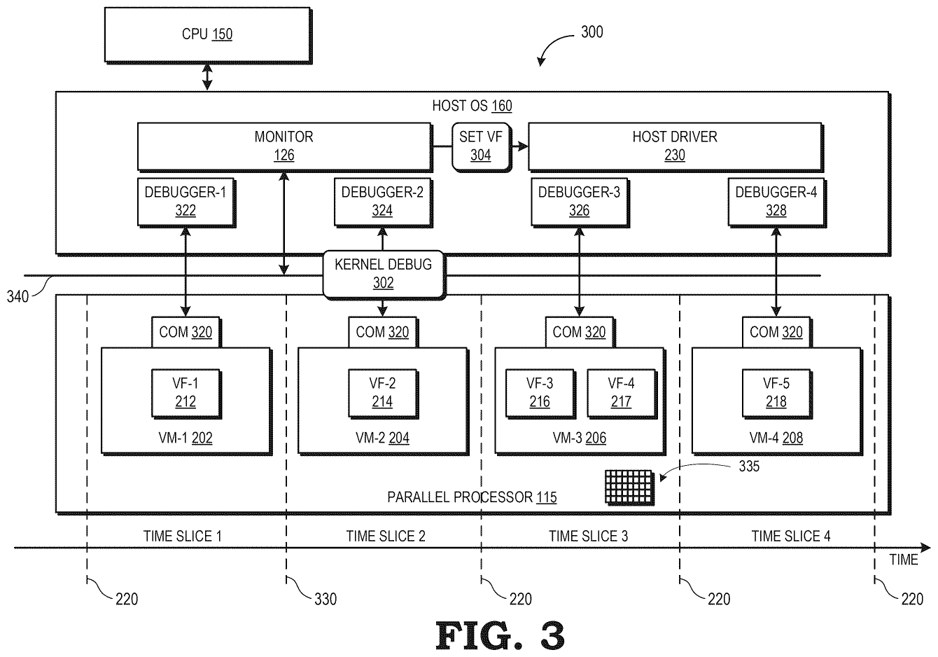

FIG. 3 is a block diagram 300 illustrating the monitor 126 halting world switching at the virtualized hardware resource and switching an active partition to a virtual function based on a request from a debugger in accordance with some embodiments. In the illustrated example, virtual machines VM-1 202, VM-2 204, VM-3 206 and VM-4 208 and their associated virtual functions VF-1, 212, VF-2 214, VF-2 216, VF-4 217, and VF-5 218 share the virtualized hardware resources of the parallel processor 115 by taking turns during allocated time slices separated by world switches in round-robin fashion, as described above with respect to FIG. 2.

Each virtual machine is configured with a com port 320 through which the virtual machines communicate with a debugger. In the illustrated example, each virtual machine is associated with a dedicated debugger: VM-1 202 is associated with debugger-1 322; VM-2 204 is associated with debugger-2 324; VM-3 206 is associated with debugger-3 326; and VM-4 208 is associated with debugger-4 328. The monitor 126 listens to the com ports of each of the virtual machines and monitors traffic between the virtual machines and their respective debuggers. In some embodiments, the monitor 126 listens to the com ports of the virtual machines via an interface 340 such as a system management interface. In response to detecting initiation of a kernel debugging session by a debugger with its associated virtual machine, the monitor 126 signals the host driver 230 to halt round-robin world switching among the virtual machines and to world switch to the virtual machine for which the kernel debugging session was initiated. In some implementations, the monitor 126 signals the host driver 230 to halt round-robin world switching and to world switch to the virtual machine for which the kernel debugging session was initiated only after the debugger makes a connection via the com port and sends a debug command to read one or more registers allocated to the VF.

In the illustrated example, debugger-2 324 establishes a kernel debugging session 302 with VM-2 204. In some implementations, the debugger-2 324 issues a command to read the hardware status of the parallel processor 115. For example, the debugger-2 324 requests access to one or more registers 335 to determine whether the code is malfunctioning or to correct an error in the code. Initiation of the kernel debugging session 302 temporarily halts the CPU 150. For example, in some implementations, the debugger-2 324 inserts an interrupt instruction (e.g., INT3) into the assembly code executing at the CPU 150 that halts the CPU 150 at the instruction. However, the interrupt instruction does not halt world-switching at the parallel processor 115 which, if continued, could cause the register values to be overwritten by a subsequent virtual machine in the round-robin partitioning of the hardware resources of the parallel processor 115.

In response to the debugger-2 324 initiating the kernel debugging session 302, and, in some implementations in response to the debugger-2 324 also sending a command to access one or more registers allocated to a virtual function, the monitor 126 determines which virtual function was the active partition at the time the debugger-2 324 initiated the kernel debugging session 302 and sends a signal 304 to the host driver 230 to execute a world switch 330 to set VF-2 214 as the active partition of the virtualized parallel processor 115. In some implementations, the monitor 126 identifies VF-2 214 as the partition to be set as the active partition based on the com port 320 on which the monitor 126 detected traffic. In other implementations, the monitor 126 identifies VF-2 214 as the active partition based on a debug command sent via the com port 320 identifying which register(s) 335 the debugger-2 324 is requesting to access. The com port 320 is not encrypted and can be read and tracked by the monitor 126. The signal 304 preempts the usual round-robin order of world switching between virtual machines and sets VF-2 214 as the active partition.

Once the host driver 230 executes the world switch 330 to set VF-2 214 as the active partition (i.e., interrupting the round-robin order and “skipping back” to VF-2 214), the debugger-2 324 reads the register(s) 335, which hold the values previously stored by VF-2 214 when the debugger-2 324 initially established the kernel debugging session 302. In some implementations, after the debugger-2 324 has read the register(s) 335, the monitor 126 issues a command to the host driver 230 to restore the active partition to the previous guest (e.g., VF-3 216) and resume round-robin world-switching. Thus, round-robin world-switching resumes as soon as the debugger-2 324 has read the register(s) 335, and the other guests can continue utilizing the parallel processor 115 while debugging takes place. To ensure fairness among the guests, in some implementations, the monitor 126 instructs the host driver 230 to skip VF-2 214 in the next round of round-robin world switching to compensate for VF-2 214 having had two turns in the current round of round-robin world switching.

If multiple debuggers establish kernel debugging sessions in close succession, the monitor 126 may queue the kernel debugging sessions and place them in order of priority. In some implementations, the monitor 126 prioritizes the first debugger to initiate a kernel debugging session by issuing a first command to the host driver 230 to switch to the virtual function associated with the first debugger and then issuing a second command to the host driver 230 to switch to the virtual function associated with the second debugger after the first debugger has read the register(s) 335 for its kernel debugging session. In other implementations, the monitor 126 applies a different priority to kernel debugging sessions initiated in close succession. For example, if a certain memory region or a certain register is considered more volatile (i.e., if the value of the register is expected to change relatively quickly, such as a register that holds a value of a counter), the monitor 126 prioritizes a kernel debugging session to read the more volatile memory region or register over a kernel debugging session requesting access to a less volatile memory region or register. In yet other implementations, the monitor 126 prioritizes a kernel debugging session associated with a virtual machine that is associated with a higher number of virtual functions (e.g., VM-3 206, which is associated with VF-3 216 and VF-4 217) over a kernel debugging session that is associated with a fewer number of virtual functions (e.g., VM-1 202, VM-2 204, or VM-4 208, which are each associated with a single virtual function).

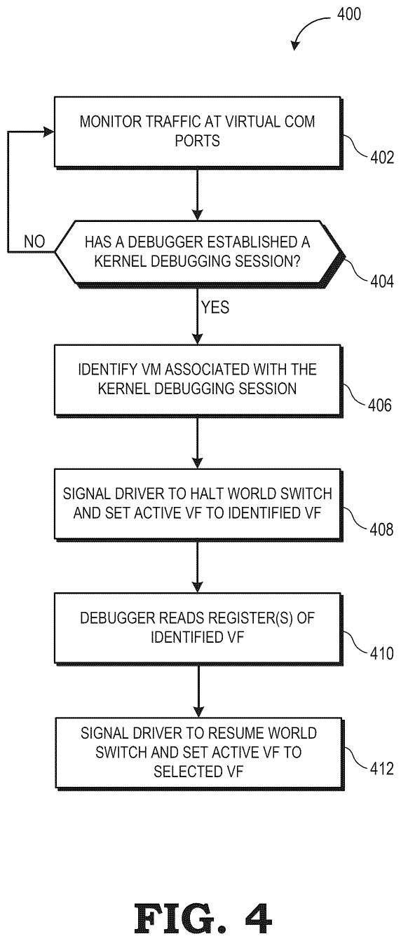

FIG. 4 is a flow diagram illustrating a method 400 for switching an active partition of a virtualized hardware resource to a virtual function based on a request from a debugger in accordance with some embodiments. In some embodiments, the method 400 is implemented in a processing system such as processing system 100.

At block 402, while a host driver such as host driver 230 rotates active partitions among virtual machines, such as virtual machines VM-1 202, VM-2 204, VM-3 206 and VM-4 208, executing at a virtualized hardware resource such as the parallel processor 115 in a round-robin fashion, a monitor or daemon or Windows Services application such as monitor 126 monitors traffic at virtual com ports 320 that are configured for each virtual machine. At block 404, the monitor 126 determines if a debugger has established a kernel debugging session 302 with an associated virtual machine via the com port.

If, at block 404, the monitor 126 determines that a debugger has not established a kernel debugging session 302, the method flow continues back to block 402 and the monitor 126 continues listening to the com ports 320. If the monitor 126 determines at block 404 that a debugger has established a kernel debugging session 302, the method flow continues to block 406.

At block 406, the monitor 126 identifies the virtual function associated with the kernel debugging session 302. In some implementations, the monitor 126 identifies the virtual function associated with the kernel debugging session 302 based on, e.g., a debug command sent via the com port 320 identifying which register(s) 335 the debugger-2 324 is requesting to access. In other implementations, in which the memory region the debugger is requesting to access is not partitioned but is instead flat and contiguous, the monitor 126 identifies the virtual function associated with the kernel debugging session 302 based on a region of memory that the debugger that established the kernel debugging session is requesting to access.

At block 408, the monitor 126 sends a signal 304 to the host driver 230 to halt the world switch 220 between round-robin active partitions and initiate a world switch 330 to set the virtual machine associated with the identified virtual function as the active partition. The world switch 330 restores the saved context of the identified virtual function such that, at step 410, the debugger is able to read the correct stored values of the register(s) 335 for the identified virtual function. Once the debugger has read the register(s) 335, the method flow continues to block 412. At block 412, the monitor 126 signals the host driver 230 to restore the active partition to the guest that was interrupted by the kernel debugging session 302. Because the virtualized hardware resource (e.g., the parallel processor 115) is only halted while the debugger reads the register(s) 335 for the affected virtual function, the other virtual functions can continue executing on the hardware resource while debugging takes place, resulting in decreased latency during debugging.

In some embodiments, the apparatus and techniques described above are implemented in a system including one or more integrated circuit (IC) devices (also referred to as integrated circuit packages or microchips), such as the processing system described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
monitoring a debugger at a virtualized hardware resource of a processing system that is partitioned into a plurality of virtual machines, wherein each virtual machine is associated with at least one virtual function; and
halting a world switch that rotates active partitions of the virtualized hardware resource in response to the debugger initiating a debugging session.

2. The method of claim 1, further comprising:
performing a world switch to a virtual function indicated by the debugger.

3. The method of claim 2, further comprising:
reading a register associated with the virtual function indicated by the debugger.

4. The method of claim 3, further comprising:
resuming the world switch in response to completing reading the register.

5. The method of claim 4, further comprising:
selectively skipping the virtual function indicated by the debugger at a next iteration of a round robin rotation of active partitions of the virtualized hardware resource.

6. The method of claim 1, wherein the debugger is connected to the plurality of virtual machines via a plurality of virtual com ports.

7. The method of claim 6, wherein monitoring the debugger comprises monitoring traffic at the virtual com ports.

8. A processing system comprising:
a hardware resource configured to be partitioned into a plurality of virtual machines, wherein each virtual machine is associated with at least one virtual function; and
a memory configured to store a debugger and a monitor, wherein the monitor is configured to signal a host of the hardware resource to halt a world switch that rotates active partitions of the hardware resource in response to the debugger initiating a debugging session.

9. The processing system of claim 8, wherein the monitor is further configured to:
signal the host to perform a world switch to a virtual function indicated by the debugger.

10. The processing system of claim 9, wherein the debugger is configured to:
read a register associated with the virtual function indicated by the debugger.

11. The processing system of claim 10, wherein the monitor is further configured to:
signal the host to resume the world switch in response to the debugger completing reading the register.

12. The processing system of claim 11, wherein the monitor is further configured to:
selectively signal the host to skip the virtual function indicated by the debugger at a next iteration of a round robin rotation of active partitions of the hardware resource.

13. The processing system of claim 8, wherein the debugger is connected to the plurality of virtual machines via a plurality of virtual com ports.

14. The processing system of claim 13, wherein the monitor is configured to monitor traffic at the virtual com ports.

15. A device comprising:
a parallel processor configured to execute requests from a plurality of virtual functions associated with a plurality of virtual machines during time partitions allocated to the plurality of virtual machines; and
a memory to store a monitor configured to:
monitor traffic between one or more debuggers and one or more of the virtual machines; and
signal a host of the parallel processor to halt world switching between time partitions of the parallel processor in response to a debugger of the one or more debuggers initiating a debugging session for a virtual function.

16. The device of claim 15, wherein the monitor is further configured to:
signal the host to perform a world switch to a virtual function indicated by the one or more debuggers.

17. The device of claim 16, wherein the one or more debuggers are configured to:
read a register associated with the virtual function indicated by the one or more debuggers.

18. The device of claim 17, wherein the monitor is further configured to:
signal the host to resume the world switch in response to the one or more debuggers completing reading the register.

19. The device of claim 18, wherein the monitor is further configured to:
selectively signal the host to skip the virtual function indicated by the one or more debuggers at a next iteration of a round robin rotation of active time partitions of the parallel processor.

20. The device of claim 15, wherein each of the one or more debuggers is connected to a virtual machine of the plurality of virtual machines via a virtual com port.
